(19) United States
(12) Patent Application Publication
(10) Pub. No.: US 2006/0220458 A1
(43) Pub. Date: Oct. 5, 2006

(54) Keyless ignition module for an automotive vehicle

(76) Inventors: Mark G. Feldman, Farmington Hills, MI (US); Vicki L. Mabee, Royal Oak, MI (US); Robert M. Schmidt, Livonia, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/098,879

(22) Filed: Apr. 5, 2005

(51) Int. Cl. B60R 25/04; H01H 27/00

(52) U.S. Cl. 307/10.3

(57) ABSTRACT

A vehicle ignition module that is activated by a signal transmitted from a vehicle entry FOB that is engageable with the module. The module includes a PCB for activating the vehicle ignition in response to the signal transmitted from the FOB and for immobilizing the vehicle ignition in the absence of the signal. An antenna assembly receives and communicates the signal to the PCB, a rotation position sensor switch is activated in response to rotation of the FOB while engaged with the module, the switch being electrically connected to the PCB, and an actuator mechanism transmits to the position switch the rotational displacement and axial displacement of the FOB.

### BACKGROUND OF THE INVENTION

The present invention relates to a vehicle ignition module. More particularly, it pertains to an ignition electronics module that is actuated by an entry FOB.

A conventional entry FOB includes a power supply and transponder, energized by the power supply for emitting a designated signal at a signature radio frequency. An antenna is required to receive the signal. An electronics module responds to the signal by activating the vehicle ignition system provided the frequency of the transmitted signal is recognized as being associated with the ignition system.

The antenna, preferably a coil antenna, should be located near the axial end of the module such that the FOB is located within the magnetic field of the antenna when it is inserted in the module. The antenna is connected to a transceiver, a transmitter-receiver that uses many of the same components for both transmission and reception. The transceiver is connected to a microprocessor, which enables the ignition system to operate, provided the FOB is recognized on the microprocessor module by its transmitted signal. The module immobilizes the ignition system in the absence of the signal.

### SUMMARY OF THE INVENTION

A vehicle ignition module according to the present invention is a keyless ignition module that includes a coil antenna and a rotation position switch integrated into an immoblizer electronics assembly. A spring-loaded latch positively retains the FOB, which activates the ignition system when inserted axially into the module. The FOB is retained in its rotated positions by engaging a recess on the FOB with a complementary protrusion on the module.

The coil antenna is electrically connected directly to the immoblizer electronics PCB assembly; the position switch is electrically connected to a PCB, which is connected to the immoblizer electronics PCB assembly.

Axial displacement of the FOB into the module causes an actuator to contact a detector switch, which produces a wake-up signal to the electronics microprocessor module. In response to the wake-up signal, the low frequency signal produced by the FOB is identified upon being received by the antenna coil and transmitted to the electronics microprocessor module.

Rotation of the FOB in the module among various detent positions causes the actuator to rotate position sensor assembly, which transmits the rotated position of the FOB to the electronics microprocessor module.

A vehicle ignition module that is activated by a signal transmitted from a vehicle entry FOB that is engageable with the module. The module includes a PCB for activating the vehicle ignition in response to the signal transmitted from the FOB and for immobilizing the vehicle ignition in the absence of the signal. An antenna assembly receives and communicates the signal to the PCB, a rotation position sensor switch is activated in response to rotation of the FOB while engaged with the module, the switch being electrically connected to the PCB, and an actuator mechanism transmits to the position switch the rotational displacement and axial displacement of the FOB.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is an isometric view showing a wireless ignition module and entry FOB for use with the module;

FIG. 2 is an isometric view of the ignition module showing the components in spaced-apart relation and located in position for assembly;

FIG. 3 is a cross section taken at plane 3-3 of FIG. 1;

FIGS. 4-8 are isometric views showing the order of assembly of the detent hub, detent hub cover, retaining ring, and detent hub assembly;

FIG. 9 is an isometric view showing the components of the position assembly in spaced-apart relation and located in position for assembly to a PCB;

FIG. 10 is isometric view showing the position assembly secured to the PCB;

FIG. 11 is a cross section taken at diametric plane 10-10 of FIG. 10;

FIG. 12 is an isometric end view showing the rotor cover and contactor assembly secured to the PCB;

FIG. 13 is isometric side view of the assembled module with the housing removed and entry FOB installed; and

FIG. 14 is a schematic diagram showing communications components including the transponder, antenna coil, and transceiver.

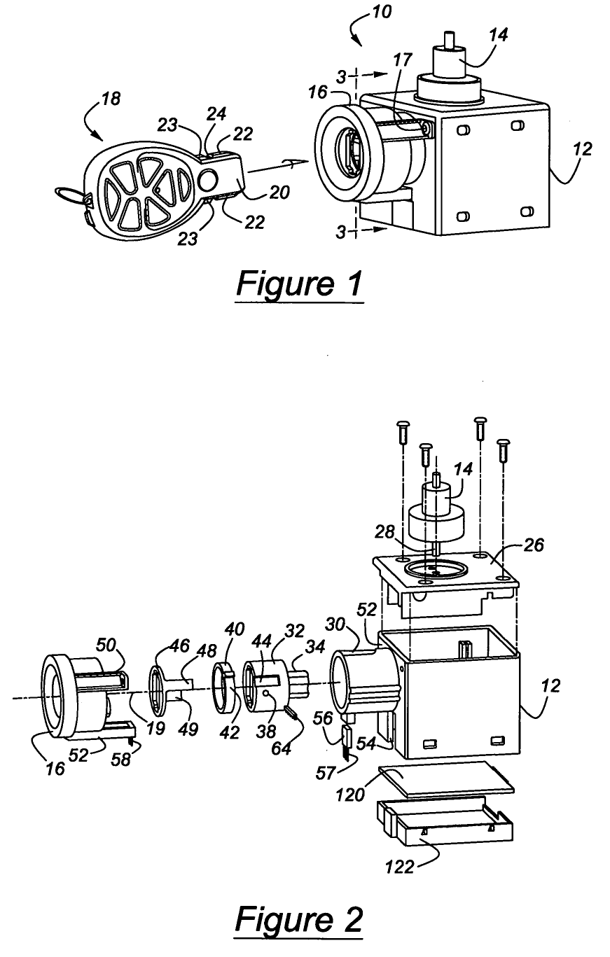

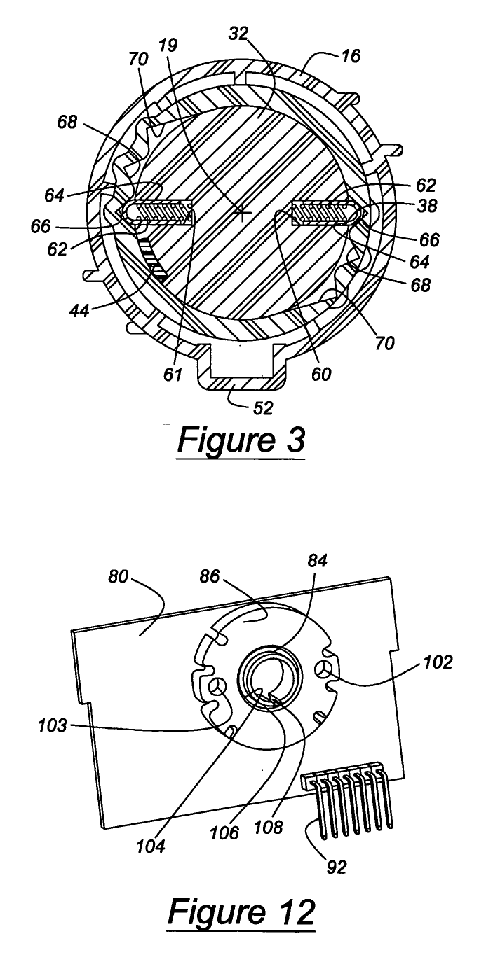

### DESCRIPTION OF THE PREFERRED EMBODIMENT

A wireless ignition module 10 for an automotive vehicle includes a housing 12, a solenoid 14 mounted on the upper surface of the housing, and an antenna coil assembly 16 secured by screws 17 to a lateral face of housing 10. A entry FOB 18, suited for use with the module, includes a stem 20 having protrusions 22, 23 located in a vertical plane and extending outward from the upper and lower surfaces of the stem 20, and a recess 24 located between the protrusions. As is customary, the entry FOB has a power supply and transponder, energized by the power supply when manual actuated by the operator for transmitting a signal at a signature radio frequency, which is received by an antenna located in the module and is used to operate the ignition system of the vehicle.

FIG. 2 shows that the top of housing 12 is closed by a cam cover 26, which is secured to the housing by screws, the cover having a opening that allows a cam follower 28, actuated by the solenoid 14, to pass through the cover and to enter the space surrounded by the housing. The housing 12 is formed with a cylindrical sleeve 30, aligned with the central axis 19 of the antenna coil assembly 16. A detent hub 32 includes a cylindrical extension 34, whose outer surface is formed with a lobe and a recess adapted to engage a complementary inner surface formed on a camshaft 36, so that the camshaft and detent hub are mutually secured to rotate together about axis 19. The detent hub 32 is formed with radially directed, diametrically opposed holes 38, hub being sized to fit within sleeve 30 of housing 12.

The cylindrical sleeve 30 is formed with a radial passageway, containing a latch 56, which is urged by a spring 57 radially toward axis 19. Latch 56 is forced radially outward by the protrusions 22 as the entry FOB 18 is inserted into module 10 until protrusions 22 pass the location of the latch, whereupon the latch engages the recess 24 on the lower surface of the entry FOB, preventing the FOB from falling from the module 10.

A retainer ring 40, which abuts the axial end surface of detent hub 32, and provides access to axial slots 44 formed on the outer surface of the detent hub 32. A detent hub cover 46 includes axial arms 48, 49, angularly spaced about the axis 19 and sized to engage the axial slots 44 on the cylindrical outer surface of the detent hub 32, so that the detent hub cover 46, retaining ring 40, and detent hub 32 are assembled in correct angular position about axis 19 and are mutually secured to rotate about axis 19 as a unit. The antenna coil assembly 16 includes several legs formed with screw holes for attachment to the axial surface 52 of housing 12.

The antenna coil assembly 16 is formed with an arm 52 located on the lower outer surface, sized to fit through a passageway 54 in the axial wall 52 of housing 12. The arm 52 carries terminals 58 of the coil antenna at the axially end of arm. Terminal 58 provide an electrical connection to a microprocessor module located on a PCB located in the housing 12.

Referring now to the cross section shown in FIG. 3, the detent hub 32 is formed with a blind radial holes 60, 61 into each of which are fitted a compression spring 62 and a detent plunger 64, which is urged by the spring radially outward through a hole 38 and into contact with the coil assembly 16.

The inner surface of the antenna coil assembly 16 is formed with two diametrically opposite sets of recesses, each set having an ENTRY/EXIT position recess 66, ACCESSORY/STOP position recess 68, and a RUN position recess 70. FIG. 3 shows the detent plungers 64 engaged with the ENTRY/EXIT position recesses 66. When the entry FOB 18 is inserted into the module 10 and rotated, the detent hub 32 rotates with the entry FOB 18 causing plungers 64 to move among the detent positions formed on the inner surface of the coil assembly 16. When the entry FOB 18 is rotated clockwise to its angular extremity of travel, each plunger 64 contacts an inclined surface adjacent the respective recess 70. When the entry FOB 18 is released, it rotates counterclockwise on the inclined surfaces into engagement with RUN recesses 70.

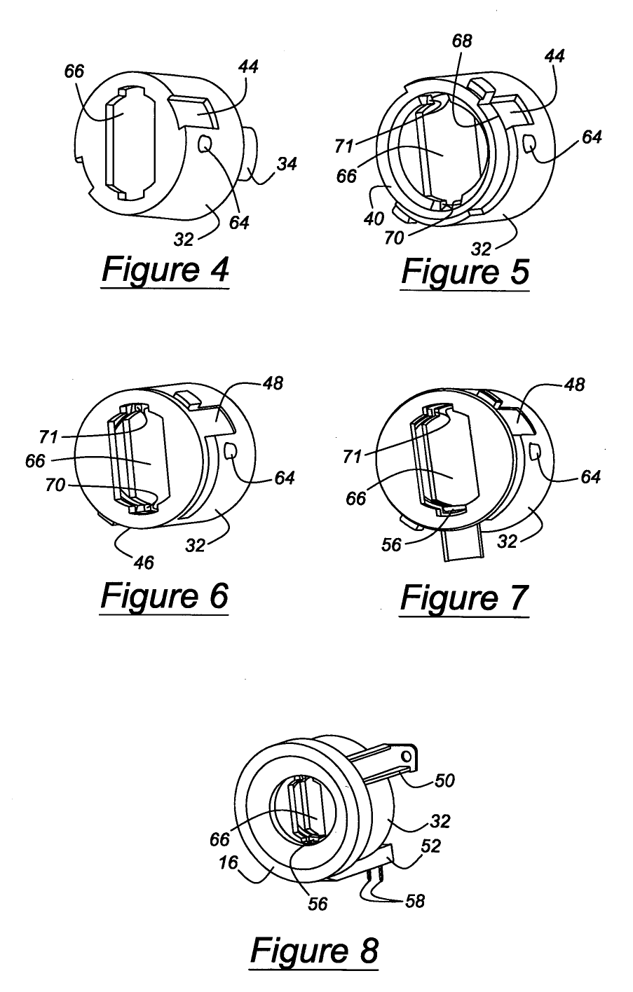

The order of assembly of components external to the housing is described with reference to FIGS. 4-9. The detent hub 32 shown in FIG. 4 has been fitted with the detent plungers 64 and springs 62, and is in position to receive the retaining ring 40. An axial end of detent hub 32 is formed with a recess having the shape of the cross section of the entry FOB 18 stem. In FIG. 5, the a retaining ring 40 is fitted over the axial end surface of the detent hub 32, such that axial slots 44 on the hub 32 are flush with surface 68 formed on the retained ring 40. Retaining ring 40 is formed with surfaces 70, 71, which are engagable by protrusions 22, 23, and recesses 24 on the entry FOB 18 when it is inserted and rotated in the module 10, thereby retaining the FOB 18 in the module in its rotated position.

FIG. 6 shows the detent hub cover 46 fitted over the retainer ring 40 and detent hub 32 such that the legs 48, 49 of the cover are fitted into respective axially slots 44 on the detent hub. Due to the engagement of the legs 48, 49 in the slots 44, the hub 32, ring 40 and cover 46 rotate as a unit when the FOB 18 is turned in the module 10.

FIG. 7 shows a entry retainer latch 56 urged by its spring 57 radially inward for engagement with the entry FOB recess 24, thereby preventing the entry FOB from falling out of the module 10.

FIG. 8 shows the antenna coil assembly 16 fitted over detent hub 32, retainer ring 40, and detent hub cover 46, the antenna contacts 58 located at the axial end of the lower arm 52, and the legs 50 in position for attachment to the end face 52 of housing 12.

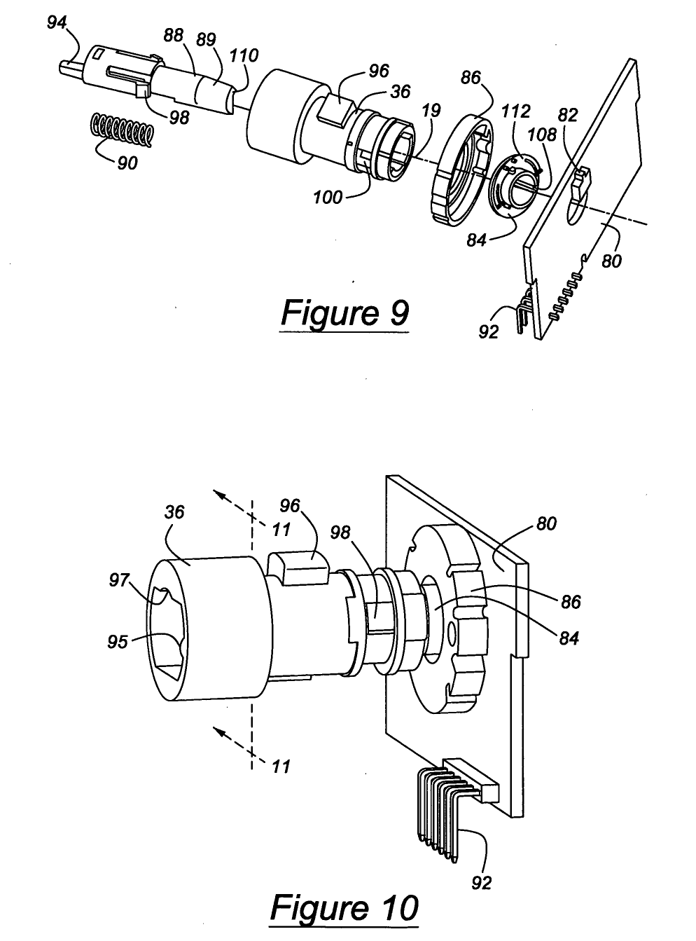

FIG. 9 illustrates a entry FOB position assembly, which is installed in housing 12 in a path on engaged components that transmits axial displacement and rotation of the entry FOB 18 from the detent hub 32 to a detector switch 82, located in the housing. The position assembly includes a PCB 80, to which is secured a detector switch 82, a contractor assembly 84, rotor cover 86, camshaft 36, a key-in actuator 88, and a key-in spring 90. The PCB 80 includes a header assembly 92 comprising electric contacts extending downward from the inner axial surface of the PCB for engagement with receptacles on a microprocessor module 120.

FIG. 10 shows the components of the position assembly installed in the housing and secured to the PCB 80. The contactor assembly 84 includes a semi-circular electrical contact rotatably secured to an annular radial leg and facing detector switch 82. The contactor assembly 84 has a central opening, through which the key-in actuator 84 passes before the PCB 80. The rotor cover 86 is secured mechanically to the inner surface of the PCB 80 and surrounds the actuator assembly 84. The key-in spring 90, a compression spring, is seated in a pocket formed in the key-in actuator 88.

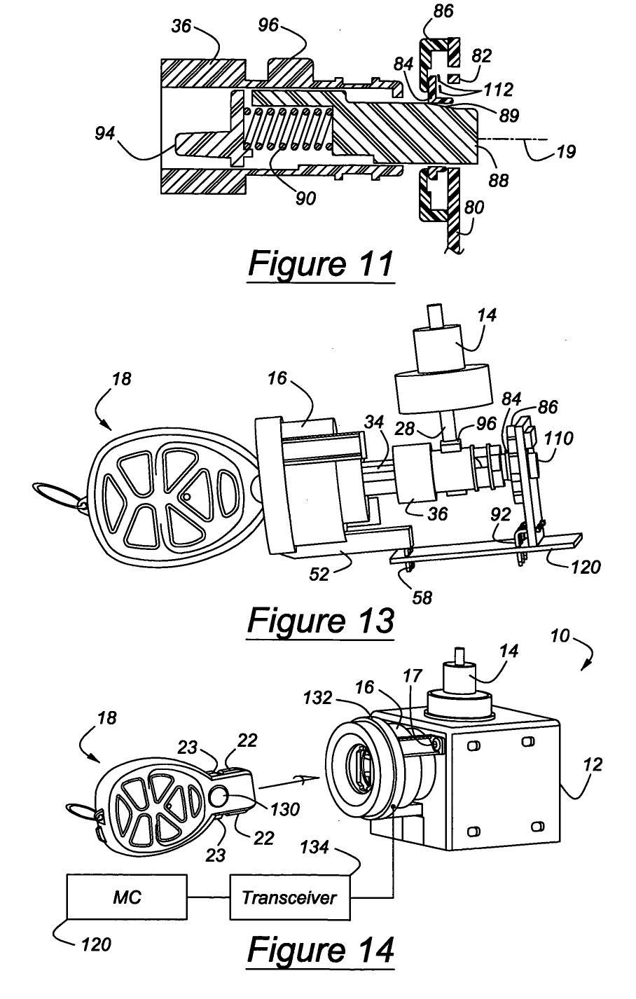

FIG. 11 shows the position assembly in its assembled condition ready to be installed in housing 12. Key-in actuator 88 is formed with an axial extension 94, which is in continual contact with the adjacent axial surface of cylinder 34 on the detent hub 32 due to the effect of the compression spring 90. The camshaft 36 has a central opening, into which the key-in actuator 88 extends. The axial surface of the camshaft 36 that faces detent hub 32 is formed with an axially-directed lobe 95 and axially-directed recess 97, by which the cylinder 34 of detent hub 32, which is formed with a complementary axially-directed lobe and recess, is rotatably secured to the camshaft. Resilient latches 98, in the form of axial fingers, secure the key-in actuator latches 98 to camshaft 36 when the actuator 88 is inserted within the camshaft. The ends of the fingers 98 latch onto the camshaft by extending through holes 100, so that the camshaft 36 and actuator 88 rotate as a unit. However, the latches permit the actuator to move axially toward the switch 82 without transmitting that axial displacement to the camshaft 36.

These engagements permits axial displacement of the detent hub 32 to be transmitted to the key-in actuator 88 but not to the camshaft 36, and rotation of the detent hub 32 to be transmitted to the camshaft but not to the key-in actuator 88. Camshaft 36 is formed with an external cam surface 96, which is continually contacted by the stem 28 of solenoid 14.

FIG. 12 shows the rotor cover 86 in position to be secured by screws through the attachment holes 102, 103, the cover providing a central opening 104, through which a rotor 84 of the contactor assembly extends to the adjacent inner surface of housing 12. The rotor 84 is free to float radially within rotor cover 86 so that it can be aligned with the key-in actuator 88. The rotor 84 provides an axial slot 108, into which the axial inner surface 110 of key-in actuator 88 extends and with which it engages. In this way, camshaft 36, key-in actuator 88, and the contractor rotor 84 rotate as a unit.

As the FOB 18 is inserted into the assembly 10, the key-in actuator 88 slides axially toward detector switch 82 with its inclined surface 89 in contact with the rotor 84. This movement brings position sensor 112 into contact with the detector switch 82, closing an electric circuit that is connected through header 92 to the microprocessor module 120. As the FOB 18 is rotated in the assembly 10, the position sensor 112 remains in contact with the detector switch 82, and a signal representing the degree of rotation of the FOB is transmitted to the microprocessor module 120.

FIG. 13 shows the position of the position switch/lock assembly as it is installed in the housing 12, but the housing removed to show the details. A microprocessor module 120, located within housing 12, is electrically connected by terminals of the header 92 and by the electrical terminals 58 on the end of the arm 52 of the coil assembly 16. The stem 28 of solenoid 14 rests on the cam surface 96 of the camshaft 36, and the cylinder 34 at the end of the detent hub 32 is shown in contact with the extension 94 on the end of the key-in actuator. As FIG. 2 shows, the bottom of housing 12 is closed by a lower cover 122, and the top of the housing is closed by the cam cover 26, on which solenoid 14 is supported.

Referring to FIG. 14, integrated in the FOB 18 is a transponder 130 for receiving a designated signal and emitting a radio signal of its own. The antenna coil assembly 16 includes an antenna coil 132 located near the axial end of the assembly 16 such that the FOB is located within the magnetic field of the antenna when it is inserted in the module 10. The antenna terminals 58 are connected to a transceiver 134, a radio transmitter-receiver that uses many of the same components for both transmission and reception. The transceiver 134 is connected to the microprocessor module 120, which enables the ignition system to operate, provided the FOB is recognized on microprocessor module 120 as the signal transmitted by the appropriate FOB, or otherwise immobilizes the ignition system.

In operation, the force required to insert the entry FOB 18 into switch/lock assembly 10 causes axial displacement of the detent hub 32 and radial displacement of the latch 56 of the entry retainer, which is mounted on the sleeve 30 of housing 12. When the entry FOB 18 is fully inserted in the assembly 10, the detent latch 56 engages the FOB recess 24 between the protrusions 22, 23, thereby preventing the FOB from falling from the lock assembly inadvertently.

When the entry FOB 18 is fully inserted, axial displacement of the detent hub assembly 32 transmits its axial movement to the key-in actuator 88, which engages the detector switch 82. The detector switch 82 closes a circuit that acts as wake-up signal to the electronic microprocessor module 120, which, in response, identifies the entry FOB 18 by a low-frequency transmission between the entry FOB 18 and the antenna coil assembly 16.

Entry FOB 18 rotates about axis 19 among the four angularly spaced positions described with reference to FIG. 3. When the FOB 18 is rotated to and past the ACCESSORY/STOP position, the FOB is locked in place by its engagement with the surfaces 70, 71 on the retaining ring 40. Rotation of the entry FOB 18 is transmitted through detent hub 32 to camshaft 36. Rotation is transmitted further from camshaft 36 to key-in actuator 88, due to the engagement of latches 98 in the latch holes 100 on the camshaft. As key-in actuator 88 rotates, it transmits rotation to the position sensor assembly, which transmits the rotated position to the electronic microprocessor module 120 through the sensor 112 and detector switch 82.

When FOB 18 is rotated clockwise to the START position and the operator releases the FOB, the position switch/lock assembly rotates counter-clockwise to the RUN position, where detent plungers 64 are seated in respective recesses 70. The force of detent springs 62 urges the detent plungers 64 away from the start position after the entry FOB 18 is released. The springs provide restoring forces to return the assembly to the RUN position as the plungers 64 slide on the inclined surfaces that extend between the RUN positions and the START positions on the detent hub 32.

Before removing the FOB 18 from the switch assembly, the user rotates the FOB clockwise from the RUN position to the ENTRY/EXIT position shown in FIG. 3. If various conditions are met, such as the transmission selector being located in the PARK position, removal of the FOB 18 from the switch assembly is permitted upon actuating solenoid 18, which then allows camshaft 30 to rotate to the ENTRY/EXIT position. Thereafter, the FOB 18 can be removed from the switch assembly.

In accordance with the provisions of the patent statutes, the present invention has been described in what is considered to represent its preferred embodiment. However, it should be noted that the invention can be practiced otherwise than as specifically illustrated and described without departing from its spirit or scope.

The invention claimed is:

1. An ignition module for operating a vehicle ignition with a FOB, comprising:
a PCB containing electronics for activating the vehicle ignition in response to the signal transmitted from the FOB and for immobilizing the vehicle ignition in the absence of the signal;
an antenna coil assembly including an antenna for receiving and communicating the signal to the PCB;
a detent hub engageable by the FOB, supported for rotation about an axis and displacement along the axis in response to movement of the FOB;
a position switch for opening and closing in response to movement of the FOB in the ignition module; and
an actuator mechanism for transmitting rotational displacement and axial displacement of the FOB from the detent hub to the position switch.

2. The ignition module of claim 1 further comprising a key retainer assembly including:
a latch that is displaced by the FOB as the FOB moves along the axis;
a spring for urging the latch toward releasable engagement with the FOB, such engagement preventing removal of the FOB from the module without first releasing the latch.

3. The ignition module of claim 1 wherein the FOB is formed with a recess, and the ignition module further comprising a key retainer assembly including:
a latch displaceable by the FOB as the FOB moves along the axis, and engageable with the recess on the FOB; and
a spring for urging the latch toward releasable engagement with the recess on the FOB, such engagement preventing removal of the FOB from the module without first releasing the latch from engagement with the recess.

4. The ignition module of claim 1 wherein the actuator mechanism comprises:
an actuator contacting the detent hub for axial displacement therewith;
a rotor engaged with the actuator for axial displacement therewith;
a sensor supported on the rotor and engageable with the position switch.

5. The ignition module of claim 1 wherein the actuator mechanism comprises:
a camshaft rotatably secured to the detent hub;
an actuator contacting the detent hub for axial displacement therewith, rotatably secured to the camshaft for rotation therewith, and axially displaceable relative to the camshaft;
a rotor engagable by the actuator for axial displacement and rotational displacement therewith;
a sensor supported on the rotor and engageable with the position switch.

6. The ignition module of claim 1 wherein the detent hub includes an outer surface formed with an axially extending lobe and a recess, the actuator mechanism comprising:
a camshaft having a central opening formed with an axially extending lobe and a recess complementary to the recess and the lobe, respectively, of the detent hub, for rotatably securing the camshaft to the detent hub;
an actuator contacting the detent hub for axial displacement therewith, including latches engaged with the camshaft for rotatably securing the actuator to the camshaft, the latches being axially disengagable from the camshaft as the actuator moves axially toward the position switch;
a rotor engagable by the actuator for axial displacement and rotational displacement therewith;
a sensor supported on the contactor and engageable with the position switch.

7. The ignition module of claim 1 further comprising:
a retaining ring formed with surfaces angularly spaced about the axis and located for engagement with the FOB when the FOB is located in the module and rotated about the axis, whereby the FOB is retained in the module by engagement with the surfaces of the retaining ring.

8. The ignition module of claim 1 further comprising:
a retaining ring formed with surfaces angularly spaced about the axis, the surfaces being located for engagement with the FOB when the FOB is located in the module and rotated about the axis, whereby the FOB is retained in the module by engagement with the surfaces of the retaining ring; and
a detent hub cover rotabably engaging the retaining ring and detent hub.

9. The ignition module of claim 1 further comprising:
a housing containing the position switch and the PCB, the antenna coil assembly being secured to an outer surface of the housing.

10. An vehicle ignition module that is activated by a transmitted signal produced on a FOB engageable with the module, comprising:
a PCB for activating the vehicle ignition in response to the signal transmitted from the FOB and for immobilizing the vehicle ignition in the absence of the signal;
an antenna assembly for receiving and communicating the transmitted signal to the PCB;
a rotation position sensor switch that is activated in response to rotation of the FOB while engaged with the module, the switch being electrically connected to the PCB; and
an actuator mechanism for transmitting to the position switch rotational displacement and axial displacement of the FOB.

11. The ignition module of claim 10 wherein the antenna assembly further comprises detent recesses mutually spaced angularly about an axis; the ignition module further comprising:
a detent hub engageable by the FOB, supported for rotation about an axis and displacement along the axis in response to movement of the FOB, including a detent plunger biased toward releasably engagement with the detent recesses.

12. The ignition module of claim 10 wherein the actuator mechanism further comprises:
a detent hub engageable by the FOB, supported for rotation about an axis and displacement along the axis in response to movement of the FOB;
an actuator contacting the detent hub for axial displacement therewith;
a rotor engaged with the actuator for axial displacement therewith; and
a sensor engaged with the rotor and engageable with the position switch in response to movement of the actuator.

13. The ignition module of claim 10 wherein the actuator mechanism comprises:
a detent hub engageable by the FOB, supported for rotation about an axis and displacement along the axis in response to movement of the FOB;
a camshaft rotatably secured to the detent hub;
an actuator contacting the detent hub for axial displacement therewith, rotatably secured to the camshaft for rotation therewith, and axially displaceable relative to the camshaft;
a rotor engagable by the actuator for axial displacement and rotational displacement therewith;
a sensor supported on the contactor and engageable with the position switch.

14. The ignition module of claim 10 wherein the actuator mechanism comprises:
a detent hub engageable by the FOB, supported for rotation about an axis and displacement along the axis in response to movement of the FOB, an outer surface formed with an axially extending lobe and a recess, the actuator mechanism comprising:
a camshaft having a central opening formed with an axially extending lobe and a recess complementary to the recess and the lobe, respectively, of the detent hub, for rotatably securing the camshaft to the detent hub;
an actuator contacting the detent hub for axial displacement therewith, including latches engaged with the camshaft for rotatably securing the actuator to the camshaft, the latches being axially disengagable from the camshaft as the actuator moves axially toward the position switch;
a rotor engagable by the actuator for axial displacement and rotational displacement therewith;
a sensor supported on the rotor and engageable with the position switch.

15. The ignition module of claim 10 further comprising:
a latch that is displaced by the FOB as the FOB moves along the axis;
a spring for urging the latch toward releasable engagement with the FOB, such engagement preventing removal of the FOB from the module without first releasing the latch; and
a retaining ring formed with surfaces angularly spaced about the axis, the surfaces being located for engagement with the FOB when the FOB is located in the module and rotated about the axis, whereby the FOB is retained in the module by engagement with the surfaces of the retaining ring.

16. The ignition module of claim 13 wherein the camshaft is formed with a cam surface extending angularly about the axis, the ignition module further comprising:
a solenoid including a follower contacting the cam surface, the solenoid follower alternately preventing rotation of the actuator mechanism and the FOB when the solenoid is deactivated, and releasing the actuator mechanism and the FOB for rotation about the axis when the solenoid is energized.
